(19) United States
(12) Patent Application Publication
(10) Pub. No.: US 2012/0027667 A1
(43) Pub. Date: Feb. 2, 2012

(54) Method for the production of hydrogen peroxide

(75) Inventors: Matej Halasa, Lessines (BE); Jean-Pierre Ganhy, Brussels (BE); Armin T. Liebens, Braine L'Alleud (BE)

(73) Assignee: SOLVAY SA, Brussels (BE)

(21) Appl. No.: 13/260,346

(22) PCT Filed: Mar. 26, 2010
(86) PCT No.: PCT/EP2010/054011

§ 371 Date: Sep. 25, 2011

(30) Foreign Application Priority Data
Mar. 27, 2009 (EP) 09156386.6

(51) Int. Cl. C01B 15/023

(52) U.S. Cl. 423/588

(57) ABSTRACT

A process for production of hydrogen peroxide which comprises the following steps: (a) hydrogenation of a working solution comprising at least one non-ionic quinone compound selected from the group consisting of anthraquinone and its derivatives, phenanthrenequinone and its derivatives, naphthoquinone and its derivatives, and benzoquinone and its derivatives, wherein the total molecular weight of optional groups attached to the quinone skeleton is lower than 500, to obtain at least one corresponding hydroquinone compound; (b) oxidation of the at least one hydroquinone compound to obtain hydrogen peroxide; and (c) separation of the hydrogen peroxide, during and/or subsequently to the oxidation step b); wherein the working solution of either step a) and/or b) comprises less than 30% by weight of organic solvent.

### CROSS-REFERENCE TO RELATED APPLICATIONS

The present application is a U.S. national stage entry under 35 U.S.C. §371 of International Application No. PCT/EP2010/054011 filed Mar. 26, 2010, which claims the benefit of the European patent application No. 09156386.6 filed on Mar. 27, 2009, the whole content of this application being herein incorporated by reference for all purposes.

### TECHNICAL FIELD OF THE INVENTION

The invention relates to a new method for the production of hydrogen peroxide, which can be achieved without the use of the substantial adjunction of organic solvent(s).

### BACKGROUND OF THE INVENTION

Hydrogen peroxide is one of the most important inorganic chemicals to be produced worldwide. The world production of H₂O₂ grew to 2.2 million tons (100% H₂O₂) in 2007. Its industrial application includes textile, pulp and paper bleaching, organic synthesis (propylene oxide), the manufacture of inorganic chemicals and detergents, environmental and other applications.

Synthesis of hydrogen peroxide is predominantly achieved by using the Riedl-Pfleiderer process. This well known cyclic process makes use of the auto-oxidation of a 2-alkyl anthrahydroquinone compound to the corresponding 2-alkyl anthraquinone which results in the production of hydrogen peroxide. Such process requires very large amounts of organic solvents.

The first step of this reaction is usually the reduction in an organic solvent of the chosen anthraquinone into the corresponding anthrahydroquinone using hydrogen gas and a catalyst.

The mixture of organic solvents, hydroquinone and quinone species (working solution) is then separated from the metal catalyst and the hydroxyquinone is oxidized using oxygen or air thus producing oxygen peroxide.

The organic solvent of choice is typically a mixture of two types of solvents, one being a good solvent of the quinone derivative (usually a mixture of aromatic compounds) and the other being a good solvent of the hydroxyquinone derivative (usually a long chain alcohol).

The use of vast quantities of organic volatile solvents produces undesirable emissions and is notoriously hazardous due to the risk of explosion and is thus less desirable.

Furthermore the use of such compounds is also uneconomic. More cost effective manufacturing processes of hydrogen peroxide are also highly desirable, particularly in view of its economic significance.

In general, productivity is defined as quantity of hydrogen peroxide produced with given quantity of working solution (ws) and expressed in grams of H₂O₂ per kilogram of working solution; state-of-the-art auto oxidation processes run with productivities of about only 15 g H₂O₂/kg of working solution (maximum). Higher productivity, meaning lower capital expenditure, is highly desirable. Separation of the peroxide produced is carried out in general in an extraction column. The size (cost) of the column is directly proportional to the distribution coefficient of H₂O₂ between extraction water and working solution. For economic operation, this coefficient has to be as high as possible.

A large number of variations of the Riedl-Pfleiderer process have been described. They mainly relates to the optimization of the working solution using novel combinations of solvents and/or anthraquinone either in term of the anthraquinone species used, their respective proportions and/or in term of the nature or respective proportion of the solvent mixture. Usually the proportion of solvent used is greater than 50% by weight. In one particular case a lower amount of solvents is used but the process requires very specific conditions to be met. Thus, in FR1.186.445, it is described the use of the 2-ethyl- and the 2-isopropyl anthraquinone at a respective ratio of 20/80 and the use of organic solvents at a concentration superior to 30% by weight.

In U.S. Pat. No. 2,966,398 it is proposed to carry out one of the two steps of the auto-oxidation process of the invention (the oxidation of the hydroquinone species) without the hydroquinone-associated solvent. To do so, once the hydrogenation step of the quinone(s) has been carried out, the temperature is reduced to obtain a crystallized form of the hydroquinone which is then separated from the mixture of solvents and then separately oxidized with a solvent of quinone to produce hydrogen peroxide. This process however still requires the use of a large amount of quinone-associated organic solvents.

Some substantially solvent-free processes have been proposed but they involved the use of very specific quinone derivatives. Such alternatives are described in WO2006/003395 and WO2000/00428.

WO2006/003395 describes the use of molten salts of quinone and hydroquinone in an auto-oxidation process to produce hydrogen peroxide. These derivatives comprise at least one anionic (such as sulfonate (SO₃⁻) or carboxylate (COO⁻)) or cationic (imidazolium, piperidinium, phosphonium, pyrazinium, ammonium, etc) moieties.

WO2000/00428 discloses the synthesis of hydrogen peroxide using the auto-oxidation process of particular anthraquinone derivatives which are described as being “CO₂₋philic”. The “CO₂-philic group” used to transform the anthraquinone compounds into suitable anthraquinone are chosen from a fluoroalkyl, a fluoroether, a silicone, an alkylene oxide, a fluorinated acrylate or a phosphazine group.

As it can be readily understood from both disclosures, the requirement to first proceed to the synthesis of these particular and elaborate quinone derivatives leads to additional manufacturing steps which in turn results in higher variable costs and is therefore highly undesirable.

There is therefore still a need to improve the known processes to overcome at least one or more of the drawbacks of the known method to obtain hydrogen peroxide.

### SUMMARY OF THE INVENTION

It is thus provided a process for production of hydrogen peroxide which comprises the following steps:
a) hydrogenation of a working solution comprising at least one non-ionic quinone compound to obtain at least one corresponding hydroquinone compound;
b) oxidation of said hydroquinone compound to obtain hydrogen peroxide; and
c) separation of said hydrogen peroxide during and/or subsequently to said oxidation step b);
wherein the working solution of either step a) and/or b) comprises less than 30% by weight of organic solvent.

### DETAILED DESCRIPTION OF THE PREFERRED EMBODIMENTS

The expression “non-ionic quinone compound” encompasses fully covalent and neutral organic compounds of the quinone type which have a fully conjugated cyclic dione structure derived from aromatic compounds by conversion of an even number of —CH═ groups into —C(═O)— groups with any necessary rearrangement of double bonds.

In a first embodiment of the present invention, at least one non-ionic quinone compound is substantially insoluble in carbon dioxide. The expression “quinone compounds substantially insoluble in carbon dioxide” means quinone compounds substantially insoluble in carbon dioxide at a pressure of 5000 psi, in particular below 5000 psi, and at a temperature of 50° C. and preferably of 100° C. In this first embodiment, the quinone compounds typically exhibit a solubility of maximum 1 mMol in carbon dioxide at a pressure of 5000 psi or below and at a temperature of 50° C., preferably of maximum 10⁻¹ mMol, more particularly of maximum 10⁻² mMol. In a preferred embodiment, the quinone compounds exhibit a solubility of maximum 1 mMol in carbon dioxide at a pressure of 5000 psi or below and at a temperature of 100° C., preferably of maximum 10⁻¹ mMol, more particularly of maximum 10⁻² mMol.

In a second embodiment of the present invention, at least one non-ionic quinone compound is selected from anthraquinone and its derivatives, phenanthrenequinone and its derivatives, naphthoquinone and its derivatives, and benzoquinone and its derivatives, wherein the total molecular weight of the optional groups attached to the quinone skeleton is lower than 500. In a preferred embodiment, the total molecular weight of the optional groups attached to the quinone skeleton is equal to or lower than 400, preferably equal to or lower than 300, more preferably equal to or lower than 200, particularly equal to or lower than 180, more particularly equal to or lower than 150, especially equal to or lower than 120, for example around 100. Preferably, the quinone compounds are alkyl substituted.

In a third embodiment, the non-ionic quinone compounds present in the working solution of the present invention contain a number of CO₂-philic functionalizing groups of less than 1 per non-ionic quinone molecule, preferably less than 0.1, in particular the non-ionic quinone compounds do not comprise any CO₂-philic group, the CO₂-philic group being especially selected from fluoroalkyl groups, fluoroether groups, silicone groups, alkylene oxide groups and fluorinated acrylate groups.

According to the present invention, most preferred are quinone compounds or mixtures thereof with low melting point temperatures such as less than 180° C., preferably less than 115° C. The preferred quinone compounds have preferably low viscosity (such as less than 10000 mPa·s, preferably less than 1000 mPa·s and even more preferably less than 100 mPa·s) at the working temperature which is usually ranging from 80 to 115° C.

Most preferred quinone compounds according to the present invention are the alkyl anthraquinones of the type commonly used in the Riedl-Pfleiderer reaction such as ethylanthraquinones (e.g., 2-ethylanthraquinone), butylanthraquinones (e.g., 2-tert-butylantraquinone) and amyl anthraquinone and a mixture thereof. By using eutectic mixtures, more common anthraquinone derivatives can be used as the mixture will be provided with a desirable low melting pointing, large liquid range and low viscosity. However if respective concentrations of the quinones in the mixture change, due for example to selective degradation of a particular quinone, desirable properties may be lost.

Amyl anthraquinone is therefore a particularly suitable quinone compound as it is provided with desirable properties in terms of low melting point, large liquid range and low viscosity and can be used either by itself or as the major component in mixtures of quinone compounds. Thus it can be used on its own and alleviate or overcome the drawbacks associated with the use of eutectic mixtures.

According to a much preferred aspect of the invention, the hydrogenation reaction is carried out with little solvent (organic and/or inorganic). The proportion of solvent is preferably less than 30 wt. %, more preferably less than 10 wt. % and even more preferably less than 5. wt. %. According to a particularly advantageous embodiment of the invention the hydrogenation step is carried in the absence of any solvents. The expression “absence of any solvents” is to be understood not to be an absolute term but to include minimal amounts, or trace, of solvent(s), due, for example, to unwanted contamination. Such a particular embodiment is particularly advantageous as it simplifies the process, increases the productivity, minimise costs and diminishes pollution due to the use of these solvents, in particular organic solvents.

The hydrogenation step can be carried out in the presence of a hydrogenation catalyst which can be a metal chosen from the platinum group such as platinum, palladium, rhodium and ruthenium which are highly active catalysts and operate at lower temperatures and lower pressures of H₂. Non-precious metal catalysts, especially those based on nickel (such as Raney nickel and Urushibara nickel) have also been developed as economical alternatives, but they are often slower or require higher temperatures. The catalyst can be supported on a solid support such as a sodium silicoaluminate support. A palladium catalyst on a sodium silicoaluminate support has demonstrated good results.

The working solution of quinone compounds can be first pre-heated before the hydrogenation reaction takes place. The working solution can be preheated at a temperature up to 180° C., advantageously up to 140° C. and more preferably up to 120° C. The temperature may be chosen to achieve good processability of the material (low viscosity). As mentioned before a viscosity of less than 10000 mPa·s, preferably less than 1000 mPa·s and even more preferably less than 100 mPa·s is preferred.

The hydrogenation reaction is preferably carried out by introduction of pure hydrogen gas, advantageously under pressure. Suitable hydrogen pressures, which depend upon the size of the hydrogenation reactor, can be up to 3 MPa but are generally chosen below 0.5 MPa for economic reasons.

The hydrogenation reaction is advantageously carried out in a stirred slurry reactor and the temperature is preferably maintained at a temperature of 180° C. or below, preferably around 90° C., and is preferably constant.

The hydrogenation reaction is stopped after some time, preferably when a pre-determined minimum hydrogenation level (proportion of hydrogenated quinone species in working solution) has been reached. Such a pre-determined level can be of at least 5 wt. %, preferably 10 wt. % or higher.

Once the hydrogenation reaction has been carried out, the oxidation step may take place directly. The oxidation step is carried out with a minimum (i.e. less than 30 wt. %) of organic solvent. It is preferred that that less than 10 wt. %, and even more preferably less than 5 wt. %, of organic solvent is used. According to a particularly advantageous embodiment of the invention the oxidation step is carried in the absence of any organic solvents.

It is further preferred that both the hydrogenation and the oxidation step are carried out with very little organic solvent such as 10 or even 5 wt. % or without organic solvent. This feature renders the process of the invention particularly environmentally friendly. The expression “absence of any organic solvents” is, again, to be understood not to be an absolute term but to include minimal amounts, or trace, of organic solvent which may be due, for example to contamination.

The oxidation reaction is usually carried out at a constant temperature close or superior to the melting point of the hydroquinone but inferior to the boiling point of the extraction solvent at the given pressure. In one particular embodiment of the invention based on the use of amyl anthraquinone, such temperature is chosen in the range of from 85 to 95° C., such as 92° C. The source of oxygen can be pure oxygen, but may also be air. The reaction mixture is conveniently maintained at a constant temperature until completion of the oxidation reaction.

According to a particular embodiment of the invention, the oxidation step is carried in presence of at least one extraction solvent. This solvent is advantageously water but can also be an alcohol, ionic liquid or similar compounds. Mixtures of these solvents can also be used.

The proportion of extraction solvent used can range from 0 wt. % to 99 wt. %. Usually the concentration of the extraction solvent should not be lower than 1.5 wt. % for safety reasons. Advantageously the concentration of the extraction solvent is lower than 20 wt. %, preferably lower than 10 wt. % and suitably ranges from 1.5 to 7.5 wt. %.

Hydrogen peroxide is extracted from the reaction mixture, either during the oxidation step and/or subsequently thereof for example by using liquid-liquid extraction and in particular water extraction methods which are well known in the art. The extraction solvent and the hydrogen peroxide can thus be removed from the working solution by known drying techniques (e.g., by decantation) and the working solution recycled to the hydrogenator.

Other separation methods, such as distillation, membrane techniques, precipitation, etc. can be advantageously used.

Advantageously additional steps to remedy minor degradation of the quinone compounds in the working solution can be carried out, such as removal or regeneration of degradation products or top-up addition of at least one of the quinone compounds.

Thus the method of the invention can be operated in a cyclic configuration, wherein after separation of the hydrogen peroxide the working solution is recycled to constitute at least part of said working solution of step a). Successive steps of hydrogenation and oxidation can then take place in a continuous cyclic process.

The invention is also directed to hydrogen peroxide, purified or not, obtained or obtainable by using the process above described. A further object of the invention is the use in a Reidl-Pfleiderer type process of a small amount of solvent, such as 30% wt. %, preferably 10% wt. % and more preferably 5 wt. % or less. Advantageously no organic solvent is used in the reaction.

A further object of the invention is a system, installation or equipment for the production of hydrogen peroxide which is designed to carry out the process of the invention.

### EXAMPLES

Some illustrative but non-limiting examples are provided for a better understanding of the present invention and for its embodiment.

### Example 1

### Production of H₂O₂ Based on Tert-Butyl Anthraquinone and Ethyl Anthraquinone Mixture

### Example 1.1

### Hydrogenation of Anthraquinone Mixture

300 g of anthraquinone mixture (60 wt. % tert-butyl anthraquinone and 40 wt. % ethyl anthraquinone) and 4 g of hydrogenation catalyst (2% wt. reduced Pd on amorphous sodium silicoaluminate support) were loaded into batch hydrogenation reactor equipped with a gas dispersion turbine mixer (hydrogen introduced via hollow shaft). The reactor was first purged with nitrogen and preheated to 90° C. Pure hydrogen gas was introduced afterwards. Partial pressure of hydrogen was set to 1.13.10⁵ Pa.

Reaction started with hydrogen dispersion induced by the rotation of the turbine mixer (1500 min⁻¹); reaction temperature was kept at 90° C. via a heated jacket.

Reaction was stopped after 80 minutes and the hydrogenation catalyst was filtered out. The quantity of hydrogenated anthraquinones was measured indirectly spectrophotometrically (absorption at 400 nm after oxidation with oxygen and complexation with aqueous solution of titanium oxalate 50 g l⁻¹); this quantity of hydrogenated anthraquinones (hydrogenation level) was 12.9 wt. %.

### Example 1.2

### Oxidation of Reduced Anthraquinone Mixture

5.19 g of hydrogenated anthraquinone mixture from Example 1.1 (60 wt. % tent-butyl anthraquinone and 40 wt. % ethyl anthraquinone; hydrogenation level: 12.9 wt. %) and 100 ml of aqueous solution of sodium pyrophosphate (200 mg) and nitric acid (25 μl of HNO₃ 65 wt. %) were loaded into oxidation reactor. Batch oxidation reactor was a round bottom flask (500 ml), packed with PTFE stripes and mounted on a rotary evaporator, equipped with a cooler for recovering of the evaporated liquid. The temperature of oil bath was set to 92° C. and maintained constant during the whole reaction. Pure oxygen was introduced by PTFE pipe above the liquid level (1.2 l min⁻¹).

Reaction started when the oxidation reactor was immersed into the oil bath. After 10 minutes, the reaction mixture was rapidly cooled down to room temperature.

### Example 1.3

### Separation of Hydrogen Peroxide: Liquid-Liquid Extraction; Productivity

One-stage batch liquid-liquid extraction was carried out in the oxidation reactor described above, into which 100 ml of demineralized water were added. Recovered liquid was analyzed for peroxide content by means of standard ceric sulfate method or magnesium permanganate method (CEFIC Peroxygens H₂O₂ AM-7157—March 2003: Hydrogen peroxide for industrial use—Determination of hydrogen peroxide content—Titrimetric method). 200 ml of extract contained 76.4 mg of H₂O₂ (0.382 g_{H2O2} l⁻¹), which corresponds to a productivity of 14.7 g_{H2O2} kg_{ws}⁻¹ and hydrogen peroxide yield (based on the quantity of hydroanthraquinone employed) of 85.6%.

### Example 2

### Production of H₂O₂ Based on Amyl Anthraquinone

### Example 2.1

### Hydrogenation of Amyl Anthraquinone

355 g of amyl anthraquinone (purity: 91 wt. %) and 4 g of hydrogenation catalyst (2% wt. reduced Pd on amorphous sodium silicoaluminate support) were loaded into batch hydrogenation reactor equipped with a gas dispersion turbine mixer (hydrogen introduced via hollow shaft). The reactor was first purged with nitrogen and preheated to 90° C. Pure hydrogen gas was introduced afterwards. Partial pressure of hydrogen was set to 1.13*10⁵ Pa.

Reaction started with hydrogen dispersion induced by the rotation of the turbine mixer (1500 min⁻¹); reaction temperature was kept at 90° C. via heated jacket. Reaction was stopped after 232 minutes and the hydrogenation catalyst filtered out. The quantity of hydrogenated anthraquinones was measured indirectly spectrophotometrically (absorption at 400 nm after oxidation with oxygen and complexation with aqueous solution of titanium oxalate 50 g l⁻¹); this quantity of hydrogenated anthraquinones (hydrogenation level) was 40.6 wt. %.

### Example 2.2

### Oxidation of Amyl Anthrahydroquinone

5.97 g of hydrogenated amyl anthraquinone from Example 2.1 (hydrogenation level: 40.6 wt. %) and 100 ml of aqueous solution of sodium pyrophosphate (200 mg) and nitric acid (25 μl of HNO₃ 65 wt. %) were loaded into oxidation reactor. Batch oxidation reactor was a round bottom flask (500 ml), packed with PTFE stripes and mounted on a rotary evaporator, equipped with a cooler for recovering of the evaporated liquid. The temperature of oil bath was set to 92° C. and maintained constant during the whole reaction. Pure oxygen was introduced by PTFE pipe above the liquid level (1.2 l min⁻¹).

Reaction started when the oxidation reactor was immersed into the oil bath. After 16 minutes, the reaction mixture was rapidly cooled down to room temperature.

### Example 2.3

### Separation of Hydrogen Peroxide: Liquid-Liquid Extraction; Productivity

One-stage batch liquid-liquid extraction was carried out in the oxidation reactor described above, into which 100 ml of demineralized water were added. Recovered liquid was analyzed for peroxide content by means of standard ceric sulfate method or magnesium permanganate method (CEFIC Peroxygens H₂O₂ AM-7157—March 2003: Hydrogen peroxide for industrial use—Determination of hydrogen peroxide content—Titrimetric method). 200 ml of extract contained 197.8 mg of H₂O₂ (0.989 g_{H2O2} l⁻¹), which corresponds to a productivity of 33.1 g_{H2O2} kg_{ws}⁻¹ and hydrogen peroxide yield (based on the quantity of hydroanthraquinone employed) of 67.2%.

### Example 3

### Production of H₂O₂ Based on Amyl Anthraquinone

### Example 3.1

### Hydrogenation of Amyl Anthraquinone

190 g of amyl anthraquinone (purity: 91 wt. %) and 5.19 g of hydrogenation catalyst (2 wt. % reduced Pd on amorphous sodium silicoaluminate support) were loaded into batch hydrogenation reactor equipped with a gas dispersion turbine mixer (hydrogen introduced via hollow shaft). The reactor was first purged with nitrogen and preheated to 110° C. Pure hydrogen gas was introduced afterwards. Partial pressure of hydrogen was set to 11*10⁵ Pa.

Reaction started with hydrogen dispersion induced by the rotation of the turbine mixer (3000 min⁻¹); reaction temperature was kept at 110° C. via heated jacket.

Reaction was stopped after 9 minutes and the hydrogenation catalyst filtered out. The quantity of hydrogenated anthraquinones was measured indirectly spectrophotometrically (absorption at 400 nm after oxidation with oxygen and complexation with aqueous solution of titanium oxalate 50 g l⁻¹); this quantity of hydrogenated anthraquinones (hydrogenation level) was 32.4±0.8 wt. %.

### Example 3.2

### Oxidation of Amyl Anthrahydroquinone

5.26 g of hydrogenated amyl anthraquinone having a hydrogenation level of 31.0 wt. % and 100 ml of aqueous solution (1.39*10⁻³ wt. % HNO₃) of sodium stannate (10 mg) were loaded into oxidation reactor. Batch oxidation reactor was a round bottom flask (500 ml), packed with PTFE stripes and mounted on a rotary evaporator, equipped with a cooler for recovering of the evaporated liquid. The temperature of oil bath was set to 50° C. and maintained constant during the whole reaction. Pure oxygen was introduced by PTFE pipe above the liquid level (1.21 min⁻¹).

Reaction started when the oxidation reactor was immersed into the oil bath. After 40 minutes, the reaction mixture was rapidly cooled down to room temperature.

### Example 3.3

### Separation of Hydrogen Peroxide: Liquid-Liquid Extraction; Productivity

One-stage batch liquid-liquid extraction was carried out in the oxidation reactor described above, into which 100 ml of demineralized water were added. Recovered liquid was analysed for peroxide content by means of standard ceric sulfate method or magnesium permanganate method (CEFIC Peroxygens H₂O₂ AM-7157—March 2003: Hydrogen peroxide for industrial use—Determination of hydrogen peroxide content—Titrimetric method). Hydrogen peroxide yield was 64.8%.

While a number of embodiments of the invention have been described in the specification, it is apparent that these examples may be altered to provide various embodiments which use the products and processes of the invention.

1. A process for production of hydrogen peroxide which comprises the following steps:
(a) hydrogenation of a working solution comprising at least one non-ionic quinone compound selected from the group consisting of anthraquinone and its derivatives; phenanthrenequinone and its derivatives; naphthoquinone and its derivatives; and benzoquinone and its derivatives, wherein the total molecular weight of optional groups attached to the quinone skeleton is lower than 500, to obtain at least one corresponding hydroquinone compound;
(b) oxidation of said at least one hydroquinone compound to obtain hydrogen peroxide; and
(c) separation of said hydrogen peroxide from said working solution, during and/or subsequently to said oxidation step b);
wherein said working solution of either step a) and/or b) comprises less than 30% by weight of organic solvent.

2. The process according to claim 1, wherein said total molecular weight of said optional groups attached to said quinone skeleton is equal to or lower than 400.

3. The process according to claim 1, wherein said non-ionic quinone compound is substantially insoluble in carbon dioxide.

4. The process according to claim 1, wherein said non-ionic quinone compound contains a number of CO₂-philic functionalizing groups of less than 1 per non-ionic quinone molecule, said CO₂-philic group being selected from the group consisting of fluoroalkyl groups, fluoroether groups, silicone groups, alkylene oxide groups, and fluorinated acrylate groups.

5. The process according to claim 1, wherein said non-ionic quinone compound is selected from the group consisting of ethylanthraquinones, butyl anthraquinones, amyl anthraquinone, and a mixture thereof.

6. The process according to claim 1, wherein said non-ionic quinone compound or mixture of non-ionic quinone compounds present in the working solution has a melting point equal to or lower than 115° C.

7. The process according to claim 1, wherein, when said process is carried out at a temperature ranging from 80 to 120° C., said non-ionic quinone compound has a viscosity inferior to 1000 mPa·s.

8. The process according to claim 1, wherein said hydrogenation step a) is carried out with less than 30 wt. % of solvent.

9. The process according to claim 1, wherein said hydrogenation step a) is carried out in the presence of a hydrogenation catalyst metal selected from the group consisting of platinum, palladium, rhodium, ruthenium, Raney nickel, and Urushibara nickel.

10. The process according to claim 1, wherein said hydrogenation step a) is stopped after a minimum hydrogenation level of at least 5 wt. % has been reached.

11. The process according to claim 1, wherein said oxidation step b) is carried out with less than 30 wt. % of organic solvent.

12. The process according to claim 1, wherein both of said hydrogenation step a) and said oxidation step b) are carried out with less than 10 wt. % of organic solvent.

13. The process according to claim 1, wherein said oxidation step b) is carried in presence of at least one extraction solvent.

14. The process according to claim 13, wherein said extraction solvent is water.

15. The process according to claim 1, wherein the working solution recovered after separation of the hydrogen peroxide in step c) is recycled to constitute at least part of said working solution of step a).

16. The process according to claim 1, wherein said non-ionic quinone compound exhibits a solubility of maximum 1 mMol in carbon dioxide at a pressure of 5000 psi and at a temperature of 100° C.

17. The process according to claim 1, wherein said non-ionic quinone compound does not comprise any CO₂-philic group.

18. The process according to claim 1, wherein said hydrogenation step a) is carried out in the absence of any solvents.

19. The process according to claim 1, wherein said oxidation step b) is carried out in the absence of any organic solvents.
